(19) United States
(12) Patent Application Publication
(10) Pub. No.: US 2025/0106291 A1
(43) Pub. Date: Mar. 27, 2025

(54) USER PLANE PROCESSING FOR EXTENDED REALITY AND MEDIA SERVICE

(71) Applicant: Lenovo (Beijing) Limited, Beijing (CN)

(72) Inventors: Haiyan Luo, Shanghai (CN); Tingfang Tang, Beijing (CN); Genadi Velev, Darmstadt (DE); Mingzeng Dai, Shanghai (CN)

(73) Assignee: Lenovo (Beijing) Limited, Beijing (CN)

(21) Appl. No.: 18/725,056

(22) PCT Filed: Dec. 29, 2021
(86) PCT No.: PCT/CN2021/142496

§ 371 Date: Jun. 27, 2024

(51) Int. Cl. H04L 67/131; H04L 12/14; H04L 65/1066

(52) U.S. Cl. CPC H04L 67/131; H04L 12/1407; H04L 65/1066

(57) ABSTRACT

Method and apparatus for processing XR traffic are disclosed. In one embodiment, an Session Management Function (SMF) of a network architecture comprises: a processor and a transmitter coupled to the processor, wherein the processor is configured to construct XR traffic handling information based on XR traffic configuration information obtained from another network entity; and to transmit, via the transmitter, the constructed XR traffic handling information to UPF.

### FIELD

The subject matter disclosed herein generally relates to wireless communications, and more particularly relates to user plane processing for extended reality and media service.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Extended Reality (XR), Augmented Reality (AR), Virtual Reality (VR), Cloud Gaming (CG), Quality of Service (QoS), Field of View (FOV), Group of Picture (GoP), end to end (E2E), Application Data Unit (ADU), Radio Access Network (RAN), 5G core (5GC), Intra frame (I-frame), Predictive frame (P-frame), Bi-directional frame (B-frame), User Plane Function (UPF), Transport Control Protocol (TCP), Internet Protocol (IP), serial number (SN), Session initialization Protocol (SIP), domain Name System (DNS), Protocol Data Unit (PDU), PDU Session Anchor (PSA), Session Management Function (SMF), Technical Specification (TS), Access and Mobility Management Function (AMF), Policy Control Function (PCF), Unified Data Repository (UDR), Policy and Charging Control (PCC), Service Data Flow (SDF), Data Network (DN), QoS Flow ID (QFI), Packet Detection Rule (PDR), Type of Service (TOS), Forwarding Action Rule (FAR), GPRS Tunnelling Protocol (GTP), GPRS Tunnelling Protocol User Plane (GTP-U), slice/service type (SST), Single Network Slice Selection Assistance Information (S-NSSAI), service Differentiator (SD), Packet Flow Description (PFD), Packet Flow Description Function (PFDF), Network Exposure Function (NEF), Data Network Name (DNN), DN Access Identifier (DNAI), Generic Routing Encapsulation (GRE), Information Element (IE), Application Function (AF), core network (CN), Session Management (SM), QoS Enforcement Rule (QER).

Extended Reality (XR), including Augmented Reality (AR) and Virtual Reality (VR), as well as Cloud Gaming (CG), are important media applications for 5G. XR or CG application may have multiple data streams with different traffic characteristics and QoS requirements in both DL and UL. For example, there may be FOV (Field of View) stream, omnidirectional stream, video stream and audio stream, etc. Packets of the same video stream may have different frame types (e.g. I-frame, P-frame, B-frame). Different positions in the GoP (Group of Picture) may have different contributions to user experience. Accordingly, prioritizing the transmission of the more important stream is beneficial for improving the capacity.

E2E layered QoS handling mechanism to accommodate the characteristic of multiple data streams in XR and CG Services has been proposed. In one proposal, XR traffic is composed of two IP packet flows from an XR source, where the two IP packet flows are mapped into two QoS flows. In the existing proposal, the correlation between the two QoS flows cannot be identified. In another proposal, there is only a single QoS flow.

Generally, a video frame can only be decoded and reconstructed correctly if all its associated packets have been correctly received. Therefore, the frame integrity is important for improving the system performance for XR and Cloud Gaming services.

ADU (Application Data Unit) is defined as the set of packets jointly processed by the application. In view of the data burst nature of the XR and media services, a set of ADUs that are generated by the application at “roughly” the same time is referred to as a burst. Examples of ADU can be one frame, one slice of a frame, one tile of a frame, one GoP, etc. In the following description, ADU can be represented as media unit.

The 5G system has to consider the following issues of XR and media service in order to perform efficient packet dropping or XR-specific scheduling:
Issue 1: how could the application-aware parameters be provided to 5GC and further provided to RAN?
Issue 2: how does RAN node identify the correlation of QoS flows?
Issue 3: how does RAN node identify the packets belonging to the same ADU in order to perform specific user plane handling or processing?e.g., XR-specific scheduling, packet routing, packet forwarding, efficient packet dropping, etc.

The present disclosure aims at resolving the above issues.

### BRIEF SUMMARY

Method and apparatus for processing XR traffic are disclosed.

In one embodiment, an Session Management Function (SMF) of a network architecture comprises: a processor and a transmitter coupled to the processor, wherein the processor is configured to construct XR traffic handling information based on XR traffic configuration information obtained from another network entity; and to transmit, via the transmitter, the constructed XR traffic handling information to UPF. In some embodiment, the constructed XR traffic handling information indicates the UPF to extract application-aware parameters from N6 interface and paste them into extended GTP-U header of N3 or N9 interface. In some embodiment, the XR traffic handling information comprises mapping relationship between QFI and packet characteristic information.

In some embodiment, the XR traffic configuration information is XR traffic indication. In some embodiment, the XR traffic configuration information further includes possible values of packet characteristic information.

In some embodiment, the processor is further configured to obtain the XR traffic configuration information as part of PCC rule from PCF. In some embodiment, the processor is further configured to obtain the XR traffic configuration information as part of PFD management from PFD Function in NEF.

In one embodiment, the processor is further configured to transmit, via the transmitter, correlation of QFIs to a RAN node. In another embodiment, the processor is further configured to transmit, via the transmitter, mapping relationship between QFI and packet characteristic information to the RAN node.

In another embodiment, a User Plane Function (UPF) of a network architecture comprises: a processor and a transmitter coupled to the processor, wherein the processor is configured to receive, via the receiver, XR traffic handling information from SMF; and to process packets carrying XR traffic in response to the received XR traffic handling information. In one embodiment, the XR traffic handling information comprises mapping relationship between QFI and packet characteristic information.

In some embodiment, to process packets carrying XR traffic comprising: to mark each of the packets carrying XR traffic with a QFI based on the packet characteristic information received from user plane. In some embodiment, to process packets carrying XR traffic comprising: to extract application-aware parameters from N6 interface and paste them into extended GTP-U header of N3 or N9 interface.

In yet another embodiment, a method comprises constructing XR traffic handling information based on XR traffic configuration information obtained from another network entity; and transmitting the constructed XR traffic handling information to UPF.

In further embodiment, a method comprises receiving XR traffic handling information from SMF; and in response to the received XR traffic handling information, processing packets carrying XR traffic.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a first embodiment;

FIG. 2 illustrates a modified PDU session establishment procedure according to a first sub-embodiment of the first embodiment;

FIG. 3 illustrates an example of correlated QoS flows;

FIG. 4 illustrates a modified PFD management via NEF;

FIG. 5 illustrates a modified PDU session establishment procedure according to a second sub-embodiment of the first embodiment;

FIG. 6 illustrates a modified procedure of processing AF requests to influence traffic routing for Sessions not identified by an UE address;

FIG. 7 illustrates a modified procedure for PCF to acquire XR traffic configuration information from AF;

FIG. 8 illustrates a modified PDU session modification procedure according to a third sub-embodiment of the first embodiment;

FIGS. 9(a) and 9(b) illustrate two examples to enable the IP packets transmitted from application server to UPF;

FIG. 10 illustrates an example of reconstructing the header of the packet;

FIG. 11 illustrates a modified PDU session establishment procedure according to a first sub-embodiment of a second embodiment;

FIG. 12 illustrates a modified PFD management via NEF;

FIG. 13 illustrates a modified PDU session establishment procedure according to a second sub-embodiment of the second embodiment;

FIG. 14 illustrates a modified procedure for PCF to acquire XR traffic configuration information from AF;

FIG. 15 illustrates a modified PDU session modification procedure according to a third sub-embodiment of the second embodiment

FIG. 16 is a schematic flow chart diagram illustrating an embodiment of a method;

FIG. 17 is a schematic flow chart diagram illustrating a further embodiment of a method; and

FIG. 18 is a schematic block diagram illustrating another apparatus according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

In the following description, several network entities, e.g. SMF (Session Management Function), PCF (Policy Control Function), NEF (Network Exposure Function), AMF (Access and Mobility Management Function), UPF (User Plane Function), etc, in the core network are involved.

### 1. First Embodiment: 5GC (e.g. UPF) Splits One IP Packet Flow of XR Traffic into Two or More QoS Flows

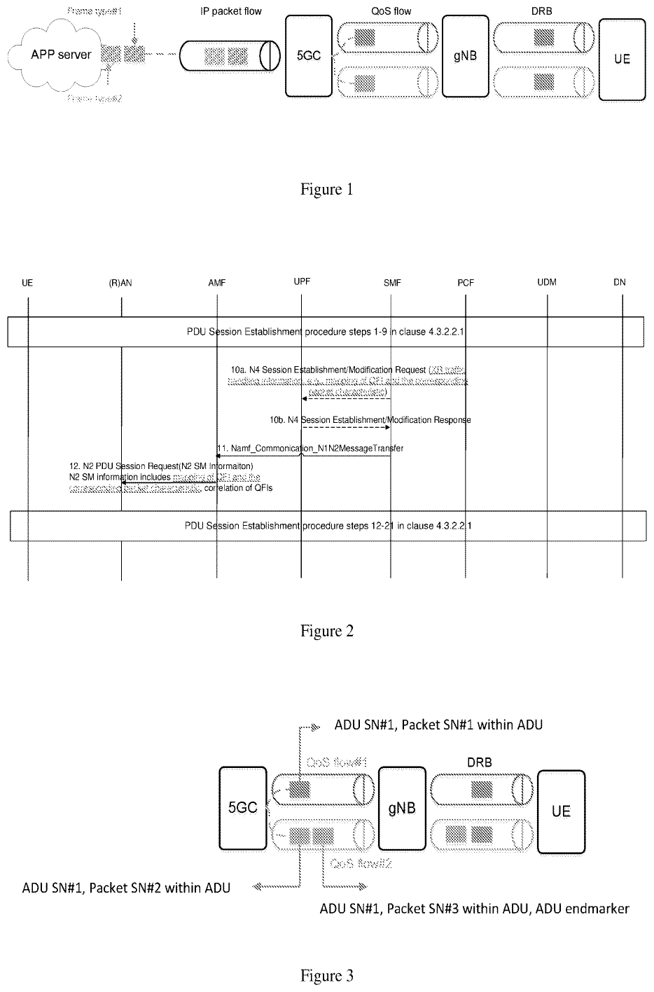

According to a first embodiment illustrated in FIG. 1, User Plane Function (UPF) receives the packets of the same IP packet flow (i.e., with the same 5-tuple) and splits the packets into two or more QoS flows (two QoS flows are illustrated in FIG. 1) based on the packet characteristic information extracted from the N6 interface which is provided by the application server. A 5-tuple refers to a set of five different values that comprise a Transport Control Protocol/Internet Protocol (TCP/IP) connection. The 5-tuple includes source IP address, source port number, destination IP address, destination port number, and the protocol in use. Packet characteristic information is a kind of application-aware information (or application-aware parameters or cross-layer parameters). The application-aware information can include ADU (Application Data Unit) related parameters (that include all the information for the 5GC and RAN to identify packets of the same ADU) such as ADU SN, ADU size, packet SN within ADU, ADU start or end indicator, and non-ADU related parameters (that include information related to identifying packet characteristics of one packet) such as frame type, packet importance, traffic type, etc. Traffic type is defined as the streaming traffic (e.g., real-time media) or the application layer signaling traffic (e.g., SIP or DNS message). The packet characteristic information refers to the non-ADU related parameters, i.e. frame type, packet importance, traffic type, etc.

A service data flow consists of one or more IP packet flows. The XR traffic can be other type of media traffic. In this disclosure, XR traffic and media traffic are interchangeable.

UPF splits the packets in one IP packet flow into two or more QoS flows, in response to receiving an XR traffic handling information from Session Management Function (SMF).

### 1.1 First Sub-Embodiment of the First Embodiment: Modified PDU (Protocol Data Unit) Session Establishment Procedure.

According to a first sub-embodiment of the first embodiment, a modified PDU session establishment procedure is introduced based on the assumption that SMF has obtained, before PDU session establishment, XR traffic configuration information for the PDU session or for the service data flow of the PDU session.

According to the first sub-embodiment of the first embodiment, UE requests a modified PDU session establishment procedure for non-roaming and roaming with local breakout case. The traditional PDU session establishment procedure, which is specified in TS 23.502 4.3.2.2.1, is incorporated in this disclosure.

FIG. 2 illustrates the modified PDU session establishment procedure according to the first sub-embodiment of the first embodiment, with underlined modified steps (i.e. steps 10a and 12) as well as the intervening steps 10b and 11 between steps 10a and 12. As shown in FIG. 2, the detailed description of steps 1-9 and 12-21 of the modified PDU session establishment procedure, that are the same as steps 1-9 and 12-21 of the traditional PDU session establishment procedure specified in TS 23.502 4.3.2.2.1, are omitted.

In steps 1-9, UE triggers the PDU session establishment procedure. AMF selects SMF and informs it to establish or modify a PDU session for the UE. SMF obtains PCC rules from PCF for the PDU session, which includes either the Application identifier (or AppId), or the service data flow filter (or flow description or SDF (Service Data Flow) template).

It is assumed that SMF knows the service data flow or the IP packet flow is XR traffic (how can SMF know that the service data flow or IP packet flow transports XR traffic will be discussed in later section 1.1.3). SMF decides that UPF splits the service data flow or IP packet flow into two or more QoS flows based on the packet characteristic information of the packet(s). It is assumed that the packet characteristic information (e.g., frame type, packet importance, traffic type, etc.) is contained in each packet transmitted over N6 interface from the application server or DN (data network) to the UPF. UPF connects to the DN or the application server that is regarded as PSA (PDU Session Anchor) UPF, which connects with the data network. Each QoS flow is associated with a QoS Flow ID (QFI).

For a first example, the IP packet flow may be split into two QoS flows with QFI #1 and QFI #2, respectively. QoS flow with QFI #1 may contain packets of I-frame, while QoS flow with QFI #2 may contain packets of P-frame.

For a second example, the IP packet flow may be split into two QoS flows with QFI #1 and QFI #2, respectively. QoS flow with QFI #1 may contain packets with packet importance value=0, while QoS flow with QFI #2 may contain packets with packet importance value=1.

For a third example, the IP packet flow may be split into four QoS flows with QFI #1, QFI #2, QFI #3 and QFI #4, respectively. QoS flow with QFI #1 may contain packets of I-frame with packet importance value=0, QoS flow with QFI #2 may contain packets of I-frame with packet importance value=1, QoS flow with QFI #3 may contain packets of P-frame with packet importance value=0, while QoS flow with QFI #4 may contain packets of P-frame with packet importance value=1.

Depending on the service requirement and SMF's implementation, there could be many other examples of splitting one IP packet flow into different QoS flows.

In summary, the QoS flows (identified by QFIs) linking to the same XR traffic (i.e., the same service data flow or the same IP packet flow) have a correlation. In addition, SMF constructs the mapping relationship between each QFI and its corresponding packet characteristic information.

### 1.1.1 Step 10a of Modified PDU Session Establishment Procedure:

In step 10a, SMF sends an N4 Session Establishment/Modification Request to UPF. According to the first sub-embodiment of the first embodiment, XR traffic handling information is included in the N4 Session Establishment/Modification Request, in addition to packet detection, enforcement, reporting rules to be installed on UPF for this PDU session. The XR traffic handling information may be for example, the mapping relationship between QFI and the corresponding packet characteristic information.

The mapping relationship between QFI and the corresponding packet characteristic information can be provided from SMF to UPF by at least one of the following three ways.

### 1.1.1.1 First Way of Implementation of Providing the Mapping Relationship Between QFI and the Corresponding Packet Characteristic Information by SMF.

A first way is to modify the IP packet filter set defined in TS 23.501 5.7.6.2.

For IP PDU Session Type, the Packet Filter Set shall support Packet Filters based on at least any combination of the following items:
Source/destination IP address or IPv6 prefix;
Source/destination port number;
Protocol ID of the protocol above IP/Next header type;
Type of Service (TOS) (IPv4)/Traffic class (IPv6) and Mask;
Flow Label (IPv6);
Security parameter index; and
Packet Filter direction.

According to the first way of providing the mapping of QFI and packet characteristic information, packet characteristic information (e.g., frame type, packet importance, traffic type, etc) is added as a new item based on which the Packet Filter Set shall support Packet Filters. That is, according to the first way, the Packet Filter Set shall support Packet Filters based on at least any combination of the following items:
Source/destination IP address or IPv6 prefix;
Source/destination port number;
Protocol ID of the protocol above IP/Next header type;
Type of Service (TOS) (IPv4)/Traffic class (IPv6) and Mask;
Flow Label (IPv6);
Security parameter index;
Packet Filter direction; and
packet characteristic information.

If one IP packet flow is split into two QoS flows, SMF shall send two PDRs (Packet Detection Rules) each containing the modified packet filter set with different packet characteristic information, respectively. For example, PDR with rule ID #1 may contain QFI #1 and the packet filter set with the packet characteristic information setting to I-frame, PDR with rule ID #2 may contain QFI #2 and the packet filter set with packet characteristic information setting to P-frame. According to the first way, only the packet filter set is modified. The PDR table defined in TS 23.501 Table 5.8.2.11.3-1 (its excerpted (related) parts are shown in the following Table 1) remains unchanged.

TABLE 1
Attributes within Packet Detection Rule

| Attribute | | Description | Comment |
|---|---|---|---|
| N4 Session ID | | Identifies the N4 session associated to this PDR. | |
| | | NOTE 5. | |
| Rule ID | | Unique identifier to identify this rule. | |
| Precedence | | Determines the order, in which the detection | |
| | | information of all rules is applied. | |
| Packet | Source | Contains the values “access side”, “core side”, | Combination of UE IP address |
| Detection | interface | “SMF”, “N6-LAN”, “5G VN internal”, “MBS internal”. | (together with Network instance, if |
| Information. | UE IP | One IPv4 address and/or one IPv6 prefix with prefix | necessary), CN tunnel info, |
| NOTE 4. | address | length (NOTE 3). | packet filter set, application |
| | Network | Identifies the Network instance associated with the | identifier, Ethernet PDU Session |
| | instance | incoming packet. | Information and QFI are used for |
| | (NOTE 1) | | traffic detection. |
| | CN tunnel info | CN tunnel info on N3, N9 interfaces, i.e. F-TEID. | Source interface identifies the |
| | Packet Filter | Details see clause 5.7.6. | interface for incoming packets |
| | Set | | where the PDR applies, e.g. from |
| | Application | | access side (i.e. up-link), |
| | identifier | | from core side (i.e. down-link), |
| | QoS Flow ID | Contains the value of 5QI or non-standardized QFI. | from SMF, from N6-LAN (i.e. the |
| | | | DN or the local DN), or from “5G |
| | | | VN internal” (i.e. local switch). |
| | | | Details like all the combination |
| | | | possibilities on N3, N9 interfaces |
| | | | are left for stage 3 decision. |

### 1.1.1.2 Second Way of Implementation of Providing the Mapping Relationship Between QFI and the Corresponding Packet Characteristic Information by SMF.

A second way is to modify the PDR table defined in TS 23.501 Table 5.8.2.11.3-1 to the following Table 2. The underlined part shows the modification.

TABLE 2
Attributes within Packet Detection Rule (Modification 1)

| Attribute | | Description | Comment |
|---|---|---|---|
| N4 Session ID | | Identifies the N4 session associated to this PDR. | |
| | | NOTE 5. | |
| Rule ID | | Unique identifier to identify this rule. | |
| Precedence | | Determines the order, in which the detection | |
| | | information of all rules is applied. | |
| Packet | Source | Contains the values “access side”, “core side”, | Combination of UE IP address |
| Detection | interface | “SMF”, “N6-LAN”, “5G VN internal”, “MBS internal”. | (together with Network instance, if |
| Information. | UE IP | One IPv4 address and/or one IPv6 prefix with prefix | necessary), CN tunnel info, |
| NOTE 4. | address | length (NOTE 3). | packet filter set, application |
| | Network | Identifies the Network instance associated with the | identifier, Ethernet PDU Session |
| | instance | incoming packet. | Information and QFI are used for |
| | (NOTE 1) | | traffic detection. |
| | CN tunnel | CN tunnel info on N3, N9 interfaces, i.e. F-TEID. | Source interface identifies the |
| | info | | interface for incoming packets |
| | Packet Filter | Details see clause 5.7.6. | where the PDR applies, e.g. from |
| | Set | | access side (i.e. up-link), |
| | Application | | from core side (i.e. down-link), |
| | identifier | | from SMF, from N6-LAN (i.e. the |
| | QoS Flow ID | Each element contains the value of 5QI or non- | DN or the local DN), or from “5G |
| | list | standardized QFI, and the corresponding packet | VN internal” (i.e. local switch). |
| | | characteristic information. NOTE 8 | Details like all the combination |
| | | | possibilities on N3, N9 interfaces |
| | | | are left for stage 3 decision. |

NOTE 8
Packet characteristic information can be frame type, packet importance and traffic type etc.

It can be seen from a comparison between Table 1 and Table 2 that the QoS Flow ID is modified into QoS Flow ID List. Each element in the QoS Flow ID List (i.e. each QoS Flow in the QoS Flow ID List) contains both QFI and the corresponding packet characteristic information. Each element in the QoS Flow ID list shares the same packet filter set (i.e., the same 5-tuple). By doing so, UPF splits one IP packet flow into two or more QoS flows.

According to the second way, the Packet filter Set contained in PDR remains unchanged.

According to a variety of the second way, the PDR table defined in TS 23.501 Table 5.8.2.11.3-1 can be alternatively modified to the following Table 3. The underlined part shows the modification.

TABLE 3
Attributes within Packet Detection Rule (Modification 2)

| Attribute | | Description | Comment |
|---|---|---|---|
| N4 Session ID | | Identifies the N4 session associated to this PDR. | |
| | | NOTE 5. | |
| Rule ID | | Unique identifier to identify this rule. | |
| Precedence | | Determines the order, in which the detection | |
| | | information of all rules is applied. | |
| Packet | Source | Contains the values “access side”, “core side”, | Combination of UE IP address |
| Detection | interface | “SMF”, “N6-LAN”, “5G VN internal”, “MBS internal”. | (together with Network instance, if |
| Information. | UE IP | One IPv4 address and/or one IPv6 prefix with prefix | necessary), CN tunnel info, |
| NOTE 4. | address | length (NOTE 3). | packet filter set, application |
| | Network | Identifies the Network instance associated with the | identifier, Ethernet PDU Session |
| | instance | incoming packet. | Information and QFI are used for |
| | (NOTE 1) | | traffic detection. |
| | CN tunnel info | CN tunnel info on N3, N9 interfaces, i.e. F-TEID. | Source interface identifies the |
| | Packet Filter | Details see clause 5.7.6. | interface for incoming packets |
| | Set | | where the PDR applies, e.g. from |
| | Application | | access side (i.e. up-link), |
| | identifier | | from core side (i.e. down-link), |
| | QoS Flow ID | Contains the value of 5QI or non-standardized QFI. | from SMF, from N6-LAN (i.e. the |
| | | | DN or the local DN), or from “5G |
| | Packet | Packet characteristic information associated with | VN internal” (i.e. local switch). |
| | characteristic | QoS Flow ID of the previous row. Details see | Details like all the combination |
| | information | NOTE 8 | possibilities on N3, N9 interfaces |
| | QoS Flow ID | Contains the value of 5QI or non-standardized QFI. | are left for stage 3 decision. |
| | Packet | Packet characteristic information associated with | |
| | characteristic | QoS Flow ID of the previous row. Details see | |
| | information | NOTE 8 | |

NOTE 8
Packet characteristic information can be frame type, packet importance and traffic type etc.

The PDR Table 3 is backward compatible with the current specification (i.e. Table 1). As shown in Table 3, packet characteristic information JE is inserted along with the QoS Flow ID. In addition, two or more pairs of QFI and the corresponding characteristic information can be contained in the PDR table (in Table 3, two pairs are indicated).

### 1.1.1.3 Third Way of Implementation of Providing the Mapping Relationship Between QFI and the Corresponding Packet Characteristic Information by SMF.

A third way is to modify the QER (QoS Enforcement Rule) table defined in TS 23.501 Table 5.8.2.11.4-1 to the following Table 4. The underlined part shows the modification.

From Table 1, one PDR may be associated with list of QoS Enforcement Rule ID(s), one of which should include the QoS Flow ID to be inserted by UPF for the downlink packets.

TABLE 4
Attributes within QoS Enforcement Rule (Modified)

| Attribute | Description | Comment |
|---|---|---|
| N4 Session ID | Identifies the N4 session associated to this QER | |
| Rule ID | Unique identifier to identify this information. | |
| QoS Enforcement Rule | An identity allowing the UP function to correlate | Is used to correlate QoS |
| correlation ID (NOTE 1) | multiple Sessions for the same UE and APN. | Enforcement Rules for APN- |
| | | AMBR enforcement. |
| Gate status UL/DL | Instructs the UP function to let the flow | Values are: open, close, close |
| | pass or to block the flow. | after measurement report (for |
| | | termination action “discard”). |
| Maximum bitrate | The uplink/downlink maximum bitrate to be | This field may e.g. contain any |
| | enforced for the packets. | one of: |
| | | APN-AMBR (for a QER that |
| | | is referenced by all relevant |
| | | Packet Detection Rules of all |
| | | PDN Connections to an |
| | | APN) (NOTE 1). |
| | | Session-AMBR (for a QER |
| | | that is referenced by all |
| | | relevant Packet Detection |
| | | Rules of the PDU Session) |
| | | QoS Flow MBR (for a QER |
| | | that is referenced by all |
| | | Packet Detection Rules of a |
| | | QoS Flow) |
| | | SDF MBR (for a QER that is |
| | | referenced by the |
| | | uplink/downlink Packet |
| | | Detection Rule of a SDF) |
| | | Bearer MBR (for a QER that |
| | | is referenced by all relevant |
| | | Packet Detection Rules of a |
| | | bearer) (NOTE 1). |
| Guaranteed bitrate | The uplink/downlink guaranteed bitrate | This field contains: |
| | authorized for the packets. | QoS Flow GBR (for a QER |
| | | that is referenced by all |
| | | Packet Detection Rules of a |
| | | QoS Flow) |
| | | Bearer GBR (for a QER that |
| | | is referenced by all relevant |
| | | Packet Detection Rules of a |
| | | bearer) (NOTE 1). |
| Averaging window | The time duration over which the Maximum and | This is for counting the packets |
| | Guaranteed bitrate shall be calculated. | received during the time |
| | | duration. |
| Down-link flow level marking | Flow level packet marking in the downlink. | For UPF, this is for controlling |
| | | the setting of the RQI in the |
| | | encapsulation header as |
| | | described in clause 5.7.5.3. |
| QoS Flow ID | QoS Flow ID to be inserted by the UPF. | The UPF inserts the QFI value in |
| | | the tunnel header of outgoing |
| | | packets. |
| Packet characteristic | Packet characteristic | Packet characteristic |
| information | information associated | information can be |
| | with QoS Flow ID of | frame type, packet |
| | the previous row | importance and traffic |
| | | type etc. |
| Paging Policy Indicator | Indicates the PPI value the UPF is required to | PPI applies only for DL traffic. |
| | insert in outgoing packets (see clause 5.4.3.2). | The UPF inserts the PPI in the |
| | | outer header of outgoing PDU. |
| Packet rate (NOTE 1) | Number of packets per time interval to be | This field contains any one of: |
| | enforced. | downlink packet rate for |
| | | Serving PLMN Rate Control |
| | | (the QER is referenced by all |
| | | PDRs of the UE belonging to |
| | | PDN connections using CloT |
| | | EPS Optimisations as |
| | | described in TS 23.401 [26]). |
| | | uplink/downlink packet rate |
| | | for APN Rate Control (the |
| | | QER is referenced by all |
| | | PDRs of the UE belonging to |
| | | PDN connections to the |
| | | same APN using CloT EPS |
| | | Optimisations as described |
| | | in TS 23.401 [26]). |

(NOTE 1)
This parameter is only used for interworking with EPC.

The QER Table 4 is backward compatible with the current specification. As shown in Table 4, packet characteristic information IE is inserted along with the QoS Flow ID. In order to enable UPF to split one IP packet flow into two or more QoS flows, SMF shall provide one PDR and corresponding QER(s), each of which contains the QFI and the packet characteristic information. For example, PDR #1 links to QER #1 and QER #2. QER #1 may contain QFI #1 and the packet characteristic information setting to I-frame. QER #2 may contain QFI #2 and packet characteristic information setting to P-frame.

According to the above-described first, second and third ways, the mapping relationship between QFI and the corresponding packet characteristic information is provided by SMF to UPF, as an implicit indication of XR traffic handling information (i.e. special user plane handling of the XR traffic is necessary). The XR traffic handling information (i.e. special user plane handling) may alternatively be sent by SMF to UPF explicitly by at least the following two ways.

### 1.1.1.4 First Way of Implementation of Explicitly Providing the XR Traffic Handling Information.

A first way of explicitly providing the XR traffic handling information is by modified FAR (Forwarding Action Rule).

The XR traffic handling information can be provided explicitly from SMF in the action of FAR. The attributes within FAR are modified as shown in following Table 5, where the underlined parts indicate the modified parts.

TABLE 5
Attributes within Forwarding Action Rule (Modified)

| Attribute | Description | Comment |
|---|---|---|
| N4 Session ID | Identifies the N4 session associated to this FAR. | NOTE 9. |
| Rule ID | Unique identifier to identify this information. | |
| Action | Identifies the action to apply to the packet | Indicates whether the packet is |
| | | to be forwarded, duplicated, |
| | | dropped, buffered or extracted. |
| | | NOTE10 |
| | | When action indicates forwarding |
| | | or duplicating, a number of |
| | | additional attributes are included |
| | | in the FAR. |
| | | For buffering action, a Buffer |
| | | Action Rule is also included and |
| | | the action can also indicate that |
| | | a notification of the first buffered |
| | | and/or a notification of first |
| | | discarded packet is requested |
| | | (see clause 5.8.3.2). |
| | | For drop action, a notification of |
| | | the discarded packet may be |
| | | requested (see clause 5.8.3.2). |

NOTE10
“extracted” indicates the UPF to extract the application-aware information from the N6 interface into the extended GTP-U header of N3 or N9 interface.

In the first way, the XR traffic handling rule can include “extracted” indication as shown in modified FAR in above Table 5. According to a variety of the first way, the XR traffic handling rule may include “full extraction”, “partial extraction”, etc. in modified FAR, where “full extraction” means UPF should extract all the application-aware parameters from the N6 interface to the extended GTP-U header; “partial extraction” means UPF should extract part of the application-aware parameters from the N6 interface to the extended GTP-U header. The XR traffic handling rule can also be introduced in PDR.

### 1.1.1.5 Second Way of Implementation of Explicitly Providing the XR Traffic Handling Information.

A second way of explicitly providing the XR traffic handling information is by introducing a new value of outer header creation in FAR.

In the FAR, the outer header creation IE instructs the UPF function to add an outer header (e.g., IP+UDP+GTP, VLAN tag), IP and possibly UDP to the outgoing packets. The attributes within outer header creation description defined in TS 29.244 8.2.56-1 are modified as shown in following Table 6, where the underlined parts indicate the modified parts.

TABLE 6
Outer Header Creation Description (Modified)

| Octet/Bit | Outer Header to be created in the outgoing packet |
|---|---|
| 5/1 | GTP-U/UDP/IPv4 (NOTE 1), (NOTE 3) |
| 5/2 | GTP-U/UDP/IPv6 (NOTE 1), (NOTE 3) |
| 5/3 | UDP/IPv4 (NOTE 2, NOTE 5) |
| 5/4 | UDP/IPv6 (NOTE 2, NOTE 5) |
| 5/5 | IPv4 (NOTE 5) |
| 5/6 | IPv6 (NOTE 5) |
| 5/7 | C-TAG (see NOTE 4) |
| 5/8 | S-TAG (see NOTE 4) |
| 6/1 | N19 Indication (NOTE 6) |
| 6/2 | N6 Indication (NOTE 6) |
| 6/3 | GTP-U/UDP/IPv4 with application- |
| | aware container in GTP-U extension |
| | header (NOTE 1). (NOTE 3) |
| 6/4 | GTP-U/UDP/IPv6 with application- |
| | aware container in GTP-U extension |
| | header (NOTE 1). (NOTE 3) |

(NOTE 1)
The SGW-U/I-UPF shall also create GTP-U extension header(s) if any has been stored for this packet, during a previous outer header removal (see clause 8.2.64).
(NOTE 2)
This value may apply to UL packets sent by a PGW-U for non-IP PDN connections with SGi tunnelling based on UDP/IP encapsulation (see clause 4.3.17.8.3.3.2 of 3GPP TS 23.401 [14]).
(NOTE 3)
The SGW-U/I-UPF shall set the GTP-U message type to the value stored during the previous outer header removal.
(NOTE 4)
This value may apply to UL packets sent by a UPF for Ethernet PDU sessions over N6 (see clause 5.8.2.11.6 of 3GPP TS 23.501 [28]).
(NOTE 5)
This value may apply e.g. to UL packets sent by a UPF (PDU Session Anchor) over N6, when explicit N6 traffic routing information is provided to the SMF (see clause 5.6.7 of 3GPP TS 23.501 [28]).
(NOTE 6)
When the “N19 Indication” or “N6 Indication” bit in the Outer Header Creation Description field is set to “1”, the UPF shall associate an “N19 Indication” or “N6 Indication” internal flag with the packet to indicate that the packet has been received from a N19 or N6 interface respectively. This indication is further used to prevent the packet from being forwarded back over N19 or N6 respectively (see clause 8.2.130).

When FAR contains outer header creation with the modified parts (e.g. 6/3 and 6/4 in Table 6) UPF extracts application-aware parameters from N6 interface into the extended GTP-U header of N3/N9 interface. The extended GTP-U header of N3/N9 interface can be regarded the same as the extended GTP-U header of the packet.

When SMF provides UPF the mapping relationship between QFI and the corresponding packet characteristic information, UPF should perform QFI marking to each packet based on the corresponding packet characteristic information (i.e. the packet characteristic information corresponding to each QFI). In addition, with explicit indication from SMF (e.g., the extraction indication or the new value of outer header creation) or implicit indicated by the mapping relationship, UPF should also extract all or part of the application-aware information (or application-aware parameters or cross-layer parameters) from N6 interface and paste them into the extended GTP-U header of N3 or N9 interface for the corresponding QoS flows associated with the packet characteristic information. That is, UPF perform a special user plane handling for the XR traffic. The details of the user plane handling for UPF will be discussed in later section 1.4.

If SMF provides RAN node (e.g., gNB in NR, eNB in LTE) with the mapping relationship of QFI and packet characteristic information, UPF may extract part of the application-aware parameters excluding the packet characteristic information used to mark the QFI. By doing so, the overhead of extended GTP-U header can be reduced. For example, if frame type (e.g. I-frame, P-frame) is used for marking the QFI, the frame type may be not included in the application-aware parameters to be pasted (included) in the extended GTP-U header. Alternatively, UPF may extract all of the application-aware parameters including the packet characteristic information used to mark the QFI (e.g. frame type).

### 1.1.2 Step 12 of Modified PDU Session Establishment Procedure:

SMF contains the correlation of QoS flows (i.e. correlation of QFIs) and the mapping relationship between QFI and packet characteristic information in the N2 SM information, e.g., in the PDU Session Resource Setup Request Transfer or PDU Session Resource Modify Request Transfer defined in TS 38.413. In modified step 12, AMF forwards the N2 SM information (e.g. correlation of QFIs, and the mapping relationship between QFI and packet characteristic information) provided by SMF to RAN node (e.g. gNB).

The correlation of QoS flows and the mapping relationship can be provided in different formats.

### 1.1.2.1 a First Format of the Correlation of QoS Flows and the Mapping Relationship:

A first format is QoS Flow Group list with the associated QFIs, or QoS Flow Group ID and the associated QFIs. For example, based on TS 38.413 9.3.4.1, PDU Session Resource Setup Request Transfer can be modified as follows (the modified parts are underlined):

### QoS Flow Setup Request List

### >QoS Flow Setup Request Item

### >>QoS Flow Identifier

>>Packet characteristic information (o)

### >>QoS Flow Group ID

Alternatively, the following structure shall replace the QoS Flow Setup Request List in PDU Session Resource Setup Request Transfer
QoS Flow Group ID list

### >QoS Flow Group ID

### >QoS Flow Identifier List

### >>QoS Flow Identifier

>>Packet characteristic information (o)

### 1.1.2.2 a Second Format of the Correlation of QoS Flows and the Mapping Relationship:

A second format is QFI and the correlated QFI(s). For example, the PDU Session Resource Setup Request Transfer can be modified as follows (the modified parts are underlined):

### QoS Flow Setup Request List

### >QoS Flow Setup Request Item

### >>QoS Flow Identifier

>>Packet characteristic information (o)
>>correlated QoS Flow Identifier List

### >>>QoS Flow Identifier

Incidentally, SMF may also send the mapping relationship between QFI and packet characteristic information to UE. For example, the mapping between QFI and packet characteristic information can be contained in the IP packet filter of the QoS rules provided by SMF. Accordingly, the UE is able to filter the packets based on the IP packet filter and marks the packet with QFI based on the packet characteristic information corresponding to the packet.

In the control plane, RAN node (e.g. gNB) receives the correlation of QoS flows from SMF, by which it is able to realize the correlated QoS flows. Besides, gNB is able to identify the packet characteristic information based on QFI according to the mapping relationship provided by SMF. In the user plane, RAN node (e.g. gNB) obtains the application-aware parameters (e.g., ADU SN, packet SN within ADU, ADU size, ADU start or end indicator, etc.) contained in the extended GTP-U header of N3 interface. Therefore, gNB is able to identify the packets of QFIs belonging to the same ADU.

In FIG. 3, gNB knows that QoS flow #1 and QoS flow #2 are correlated. Besides, it knows that the one packet from QoS flow #1, and the two packets from QoS flow #2 belong to the same ADU SN #1 based on the application-aware parameters contained in the extended GTP-U header of N3 interface.

Besides, gNB acquires the packet characteristic information based on QFI and the mapping relationship provided by SMF. Alternatively, if SMF does not send the mapping relationship to gNB, gNB can acquire the packet characteristic information directly from the extended GTP-U header of N3 interface. Based on the acquired packet characteristic value, gNB knows, for example, that packets of QFI #1 are I-frame, packets of QFI #2 are P-frame; or that packets of QFI #1 are with packet importance #1, packets of QFI #2 are with packet importance #0, etc. Then, gNB is able to perform efficient data dropping for one ADU.

1.1.3 how can SMF Know that the Service Data Flow or IP Packet Flow Transports XR Traffic?

There are at least three ways for SMF to know that the service data flow or IP packet flow transports XR traffic.

1.1.3.1 a First Way for SMF to Know that the Service Data Flow or IP Packet Flow Transports XR Traffic:

A first way is pre-configured or new standardized 5QI value for XR traffic. For example, several pre-configured 5QI values or new standardized 5QI values can be defined for XR and media service, e.g., 5QI value=11, 12, or 13 are specified or pre-configured for XR traffic. PCF includes the pre-configured 5QI value (or new standardized 5QI value) together with the SDF (Service Data Flow) template (or service data flow filter or flow description) in the PCC rules, from which SMF knows that the service data flow or the IP packet flow contains XR traffic based on the pre-configured 5QI value or new standardized 5QI value. It can be assumed that the kind of frame type, the value of packet importance, the kind of traffic type provided over the SDF by the application server are common understanding or preconfigured in SMF. For example, the possible frame type can be I-frame, P-frame and B-frame, which correspond to values 0, 1 and 2, respectively. The possible packet importance can be 0 or 1. The possible traffic type can be streaming traffic (e.g., real-time media) or the application layer signaling traffic (e.g., SIP or DNS message). In this assumption, SMF can determine the mapping relationship between QFI and packet characteristic information without being told the possible values of packet characteristics.

1.1.3.2 a Second Way for SMF to Know that the Service Data Flow or IP Packet Flow Transports XR Traffic:

A second way is new slice/service type (SST) defined for XR traffic. A new network slice type supporting XR and media service, i.e., a new SST can be defined. For example, SST=6 can be defined to represent for XR service (or media service). During PDU session establishment procedure, AMF provides the S-NSSAI of the PDU session to SMF, which includes the SST and service Differentiator (SD). SMF identifies that the PDU session is for XR service (or media service) based on the SST value. In this case, the same assumption can be made for the common understanding or preconfigured values of packet characteristics.

1.1.3.3 a Third Way for SMF to Know that the Service Data Flow or IP Packet Flow Transports XR Traffic:

A third way is per node XR traffic configuration information provided by AF. AF may provide the XR traffic configuration information in the PFD(s) (Packet Flow Description) associated with application identifier. That is, the PFD(s) include XR traffic configuration information from AF. The XR traffic configuration information indicates that the packets of the traffic flow need special user plane handling in 5GC. The XR traffic configuration information includes XR traffic indication and/or possible values of packet characteristics.

For a first example, the XR traffic configuration information can be XR traffic indication. In this case, the possible packet characteristic values are common understanding or pre-configured in SMF.

For a second example, the XR traffic configuration information includes the possible values of packet characteristics provided over service data flow from the application server. That is, the packet characteristic values, which are not common understanding or pre-configured in SMF, need to be explicitly informed from AF to the 5GC (and finally to SMF). In this way, the possible values of packet characteristics imply the service data flows or the IP packet flows transport XR traffic.

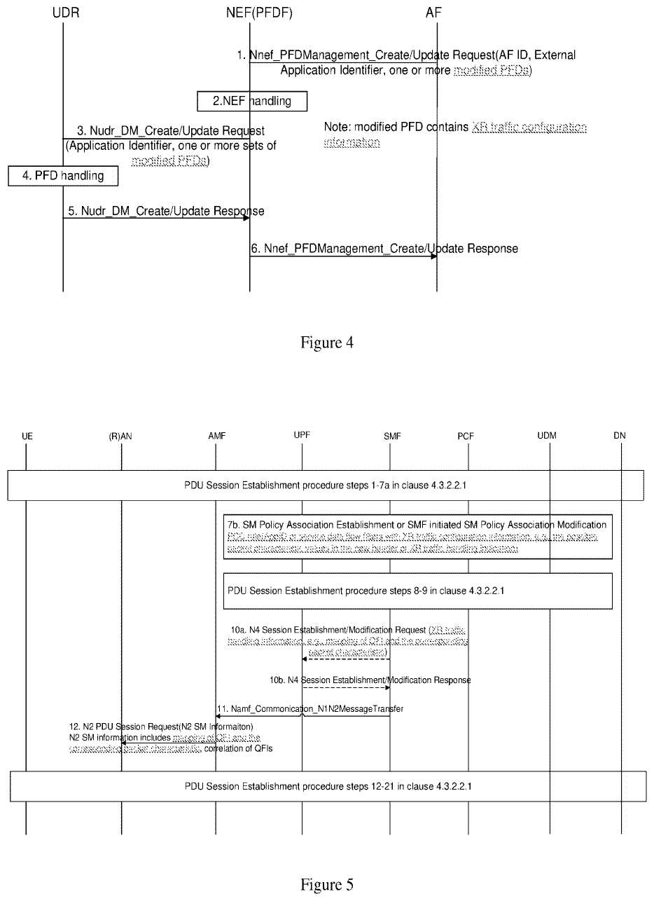

A modification to TS 23.502 4.18.2 (i.e., PFD management via NEF e.g. via (PFDF) in NEF) is proposed, as shown in FIG. 4 (with modified portions underlined). AF provides modified PFD that includes XR traffic configuration information in step 1, which are processed in NEF (i.e. in PFDF in NEF) (step 2) and stored in UDR (step 3).

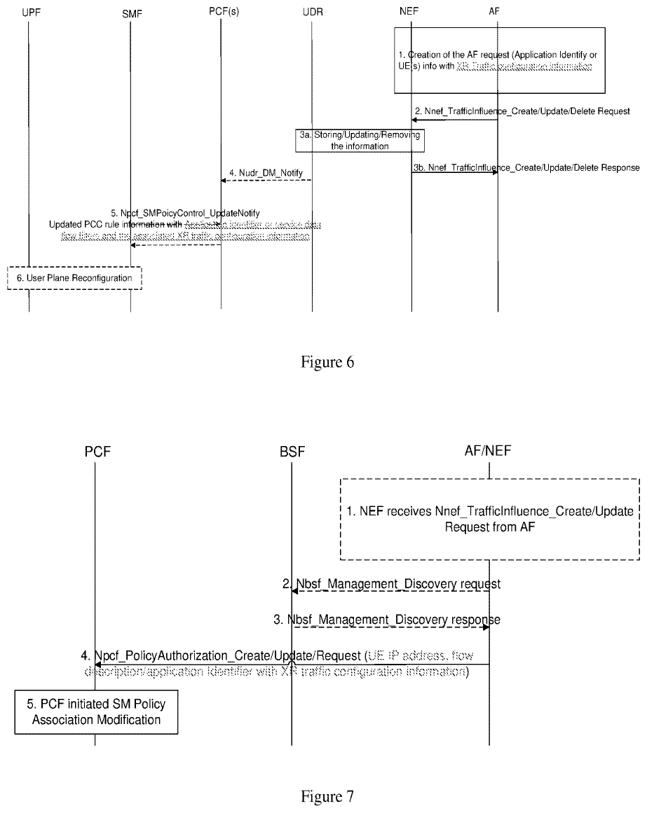

Next, the PFD including the XR traffic configuration information is provided by one of the following three alternatives (not shown in FIG. 4):
Alternative a): Per node information provisioning to SMF. The PFD Function (PFDF) in NEF shall provide PFD(s) to SMF on the request of SMF (pull mode) or on the request of PFD management from NEF (push mode).
Alternative b): Per node information is stored in UDR, and then notified to PCF and delivered to SMF via PCC rule (e.g. the PCC rule described later as shown in FIG. 6).
Alternative c): Per node information provisioning to UPF.

SMF may receive the modified PFD(s) by pull mode or push mode. By utilizing the PFD management in the UPF procedure defined in TS 23.502 FIG. 4.4.3.5-1, SMF provides the application identifier and the associated PFD(s) to UPF. During the PDU session establishment, PCF provides SMF with the application identifier in the PCC rules. SMF forwards the application identifier to UPF. UPF finds the PFD(s) associated with the application identifier based on application identifiers and their associated PFD(s) previously received from SMF. Based on the XR traffic configuration information contained in the associated PFD(s), and optionally further based on the mapping of QFIs and the corresponding packet characteristic information, UPF realizes that the IP packet flow is for XR traffic, and it shall perform special user plane handling for XR traffic.

1.2 Second Sub-Embodiment of the First Embodiment: Modified PDU Session Establishment Procedure with PCF Involved.

According to a second sub-embodiment of the first embodiment, a modified PDU session establishment procedure is introduced based on the assumption that PCF (Policy Control Function) has obtained the XR traffic configuration information from AF, either directly or indirectly.

According to the second sub-embodiment of the first embodiment, UE requests a modified PDU session establishment procedure specified in TS 23.502 4.3.2.2.1 for non-roaming and roaming with local breakout case, with the following modifications as shown in FIG. 5 (with modifications underlined).

In modified Step 7b, SMF may perform an SM Policy Association Establishment procedure as defined in clause TS 23.502 4.16.4 to establish an SM Policy Association with PCF and get the default PCC rules for the PDU session. The modification to step 7b only relates to getting PCC rules from PCF to SMF. In the PCC rules, Application Identifier (i.e., AppID) or service data flow filter (or flow description) and the associated XR traffic configuration information are provided. The XR traffic configuration information applies to the Application Identifier or the service data flow filters. Optionally, the applied Application identifier list or service data flow filter ID list can be provided together with the XR traffic configuration information from AF. That is, the XR traffic configuration information applies to the indicated Application identifier list or service data flow filter ID list. Upon receiving the modified PCC rules from PCF, SMF decides that UPF splits the service data flow or IP packet flow into two or more QoS flows.

Modified steps 10 and 12 of FIG. 5 are the same as modified steps 10a and 12 of FIG. 2. Please refer to section 1.1.1 and 1.1.2 for the detailed description of modified steps 10 and 12 of FIG. 5.

1.2.1 how can PCF Acquire the XR Traffic Configuration Information from AF Before PDU Session Establishment?

PCF can acquire the XR traffic configuration information from AF by a modification to TS 23.502 4.3.6.2 (i.e., Processing AF requests to influence traffic routing for Sessions not identified by an UE address), as shown in FIG. 6 (with modifications underlined).

In modified step 1, the AF request includes Application Identifier or UE(s) info with XR traffic configuration information, where UE(s) info includes the identifiers of the UE(s) that the request is targeting, i.e. an individual UE, or a group of UE represented by Internal Group Identifier, or any UE accessing the combination of DNN (Data Network Name), S-NSSAI (Single Network Slice Selection Assistance Information) and DNAI(s) (DN Access Identifier). The XR traffic configuration information from AF can include XR traffic indication, and optionally packet characteristic values transferred over N6 interface.

In modified step 5, PCF updates SMF with the corresponding new PCC rule(s) by invoking Npcf_SMPolicyControl_UpdateNotify service operation. In the new PCC rule(s), Application Identifier (i.e., AppID) or service data flow filter (of flow description) and the associated XR traffic configuration information from AF are provided.

### 1.3 Third Sub-Embodiment of the First Embodiment: Modified PDU Session Modification Procedure.

According to a third sub-embodiment of the first embodiment, a modified PDU session modification procedure is introduced based on the assumption that AF sends AF request upon the notification of PDU session establishment event. It is assumed that the AF registered to be notified for the PDU Session Status changes. Upon receiving the notification of PDU session establishment event, AF may utilize procedure defined in TS 23.502 4.3.6.4 (i.e., Transferring an AF request targeting an individual UE address to the relevant PCF) to provide the XR traffic configuration information to PCF for the established PDU session. The procedure defined in TS 23.502 4.3.6.4 can be modified as FIG. 7 (with modifications underlined).

In modified step 4, AF/NEF (i.e. AF or NEF) invokes the Npcf_PolicyAuthorization service to PCF to transfer the AF request. In the AF request, UE IP address, flow description or application identifier with XR traffic configuration information are included.

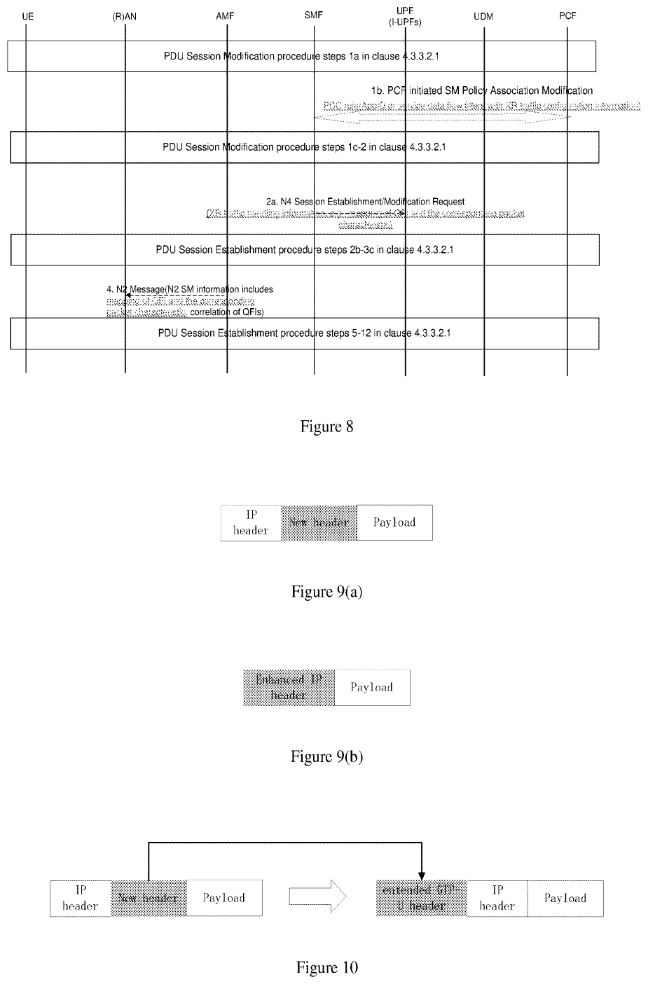

After receiving the XR traffic configuration information from AF for the PDU session, PCF will trigger the PDU session modification procedure as shown in FIG. 8, which is a modified procedure to TS 23.502 4.3.3.2 (with modifications underlined).

In modified step 1b, PCF provides PCC rules which include Application Identifier (i.e., AppID) or service data flow filter and the associated XR traffic configuration information to SMF.

In modified step 2a, SMF provides the XR traffic handling information (e.g., mapping relationship between QFI and the corresponding packet characteristic information) in the N4 session modification Request. The modified step 2a is the same as step 10a in FIG. 2 or 5.

In modified step 4, AMF forwards the N2 SM information (e.g. correlation of QFIs, and the mapping relationship between QFI and packet characteristic information) provided by SMF to RAN node (e.g. gNB). The modified step 4 is the same as step 12 in FIG. 2 or 5.

If the XR traffic configuration information from AF is provided for group UE or any UE in FIG. 6, the PDU session modification procedure may be triggered by updating the related PCC rule.

### 1.4 Fourth Sub-Embodiment of the First Embodiment: User Plane Handling of UPF (Common Part).

It is assumed that application-aware parameters provided by the application server may include ADU SN (sequence number), ADU size, packet SN within ADU, ADU start or end indicator, frame type, packet importance, traffic type, etc. Accordingly, the application-aware parameters can be classified into two categories:

Category 1 (e.g. ADU related parameters): it includes all the information for 5GC and/or RAN node to identify packets of the same ADU, which includes ADU SN, ADU size, packet SN within ADU, ADU start or end indicator, etc.

Category 2 (non-ADU related parameters): it includes information that are not closely related with how to identify packets of one ADU, which includes the packet characteristic information, e.g., frame type, packet importance, traffic type etc. The information in Category 2 can be regarded as packet characteristic information.

UPF receives downlink IP packets through N6 interface from application server of the DN (Data Network). FIGS. 9(a) and 9(b) show two options to enable the IP packets transmitted from Application server to UPF to contain the application-aware parameters, which targets the issue 1 mentioned in the background part.

As shown in FIG. 9(a), a new header is added between IP header and the payload. That is, a new protocol layer is defined between IP layer and the payload. All the application-aware parameters are included in the new header. 3GPP can introduce a brand-new protocol layer, or utilize the existing protocol layer. As an example, GRE or GTP-U header can be considered as the new header to include all the application-aware parameters without modification or with modification, e.g., adding new IEs (Information Elements). Take GRE header as an example, the sequence number IE can be utilized to convey ADU SN and packet SN within the ADU. Besides, new IEs can be introduced to include new parameters like ADU start or end indicator, ADU size, etc. Take GTP-U header as another example, the sequence number IE can be utilized to convey ADU SN and packet SN within the ADU. The length IE can be utilized to convey ADU size. Alternatively, a new extension header type named application-aware container in TS 29.281, e.g., next extension header field value=11000011 or other value can be introduced to represent the application-aware container. That is, in the new extension header, all the application-aware parameters can be included in the application-aware container. In short, extended GRE header or extended GTP-U header can be utilized as the new header.

FIG. 10 illustrates an example of reconstructing the header of the packet, taking the option shown in FIG. 9(a) as original packet format. As mentioned earlier, there are two categories of the application-aware parameters. In this example, UPF should be configured to extract the application-aware parameters from the N6 interface and perform different user plane handling towards parameters belonging to both categories. For example, UPF reads the new header between IP header and the payload and perform different user plane handlings.

Regarding the parameters belonging to category 1 (i.e., ADU-related parameters), UPF should extract them and paste them into the extended GTP-U header of the N3 and/or N9 interface(s). As shown in FIG. 10, UPF copies (extracts) the application-aware parameters of category 1 from the new header and pastes them into the extended GTP-U header, or into the application-aware container of the extended GTP-U header. UPF reconstructs the packet structure by discarding the new header between IP header and the payload, and adding the extended GTP-U header containing the application-aware parameters in front of the IP header and the payload. That is, UPF adds the extended GTP-U header containing the application-aware parameters in front of the IP header and the payload. Besides, if SMF also provides the ADU level QoS parameters (e.g., ADU error rare, ADU delay budget, ADU average window, etc) to UPF, UPF may perform efficient data dropping, e.g., the non-transmitted part of an XR frame will be discarded at the transmitter if any part of the ADU or frame has lost or exceeded the frame or ADU delay budget.

Regarding the parameters belonging to category 2 (i.e., non-ADU related parameters), UPF should mark the IP packet with the QFI based on the packet characteristic information extracted from the new header of the packet. For example, packets of I-frame may be marked with QFI #1, packets of P-frame may be marked with QFI #2. For another example, packets of I-frame with packet importance #1 may be marked with QFI #1, packets of I-frame with packet importance #2 may be marked with QFI #2, packets of P-frame with packet importance #1 may be marked with QFI #3, packets of P-frame with packet importance #2 may be marked with QFI #4. Since gNB is able to identify the packet characteristic information from the QFI by configuration, in order to avoid redundant information in the extend GTP-U header and also reduce the overhead of user plane, UPF shall discard the parameters used for QFI marking after QFI mapping. For example, the frame type and/or packet importance shall be discarded and not pasted into the extended GTP-U header, if the frame type and/or packet importance are used for QFI marking. Incidentally, if only one non-ADU related parameter (e.g., frame type) is used to link the QFI, then other non-ADU related parameters (e.g., packet importance, traffic type) can still be pasted into the extended GTP-U header.

As shown in FIG. 9(b), the IP header is modified (as modified IP header) with new parameters to include all the application-aware parameters either by utilizing the existing IEs in the IP header or adding new IEs in the IP header. The option in FIG. 9(b) is assumed to be transparent to the existing IP network. In this option, UPF may extract the required parameters from the IP header, e.g., extract the non-ADU related parameters in order to mark the packet with the corresponding QFI, or extract the ADU related parameters in order to perform efficient data dropping, or paste the application-aware parameters into the extended GTP-U header of N3 or N9 interface.

### 1.5 Summary of the First Embodiment:

According to the first embodiment, in response to the XR traffic handling information received from SMF, UPF processes the packets carrying XR traffic. In particular, the UPF splits one IP packet flow into two or more QoS flows (e.g. by marking the packets with different QFIs) based on the packet characteristic information received from the user plane. Besides, UPF extracts other application-aware parameters from the N6 interface and pastes them into the extended GTP-U header of N3 or N9 interface, i.e. in response to the XR traffic handling information received from SMF as an indication of extracting application-aware parameters from N6 interface. SMF constructs the XR traffic handling information (e.g., the mapping relationship between QFI and the packet characteristic information) based on the XR traffic configuration information from AF (e.g., XR traffic indication, optionally the possible values of packet characteristic information) received from either PCF (per session or per node) as part of PCC rule, or from PFD Function in NEF (per node) as part of PFD management, or from the special 5QI or SST.

SMF can also determine the correlation of QFIs and inform the RAN node (e.g. gNB) of the same. Optionally, SMF can also inform gNB of the mapping relationship between QFI and the packet characteristic information in order to reduce overhead of the extended GTP-U header.

The first embodiment enables XR specific user plane handling (e.g., XR specific scheduling, efficient data dropping etc.) in gNB.

### 2. Second Embodiment: Application Server Splits XR Traffic into Two or More IP Packet Flows

According to a second embodiment, it is assumed that the application server has split the XR traffic into two or more IP packet flows or service data flows. The two or more IP packet flows may have different IP 5-Tuples (a source IP address, a source port number, a destination IP address, a destination port number, and the protocol in use). Alternatively, the two or more IP packet flows may share the same source IP address and the same target IP address but with different port numbers. Further alternatively, the two or more IP packet flows may share the same IP 5-tuple, but with different IPv4 ToS or IPv6 flow label or IPv6 traffic class and mask.

It is assumed that each IP packet flow provided by the application server will be mapped to one QoS flow. In other words, in the second embodiment, the 5GC (e.g. UPF) is not necessary to further split the IP packet flow into two or more QoS flows. On the other hand, RAN node is necessary to obtain the correlation between IP packet flows (or between QoS flows mapped from the IP packet flows).

### 2.1 First Sub-Embodiment of the Second Embodiment: Modified PDU Session Establishment Procedure.

According to a first sub-embodiment of the second embodiment, a modified PDU session establishment procedure is introduced based on the assumption that SMF has obtained XR traffic configuration information before PDU session establishment. The XR traffic configuration information may include the correlation of PFDs (Packet Flow Descriptions), or the correlation of service flow filters (or flow descriptions). Optionally, XR traffic configuration information may also include the packet characteristic information corresponding to the PFD or service flow filter.

For example, service flow filter #1 (or PFD #1) and service flow filter #2 (or PFD #2) are correlated. Service flow filter #1 (or PFD #1) may include packets of I-frame, while service flow filter #2 (or PFD #2) may include packets of P-frame. Alternatively, service flow filter #1 (or PFD #1) may include packets with packet importance #0, while service flow filter #2 (or PFD #2) may include packets with packet importance #1.

Accordingly, the packet characteristic information is configured over control plane, which reduces the overhead of user plane. That is, some packet characteristic information (e.g. frame type, packet importance, traffic type, etc) will not be contained in the application-aware information (or application-aware parameters) over N6 interface.

On the other hand, if the packet characteristic information corresponding to the service flow filter or PFD is not provided by AF over control plane, it will be transmitted over user plane over N6 interface together with other application-aware parameters.

FIG. 11 illustrates a first sub-embodiment of the second embodiment, which is a modified PDU session establishment procedure that includes modified steps 10a and 12 (with underlined) compared to traditional PDU session establishment procedure specified in TS 23.502 4.3.2.2.1. Steps 10b and 11 between steps 10a and 12 are also illustrated.

Based on the XR traffic configuration information provided by AF, SMF obtains the application identifier, the associated PFD(s) (or service data flow filter or flow description) and the correlation of PFD(s) based on PFD management. SMF may also obtain the packet characteristic information corresponding to the service flow filter or PFD. SMF determines the corresponding QFI for each PFD or service data flow filter (or flow description). SMF also determines the correlation of QoS flows based on the correlation of PFDs or service data flow filter (or flow description). SMF also determines the packet characteristic information associated with QFI based on the XR traffic configuration information, i.e. SMF determines the mapping of QFI and packet characteristic information.

In step 10a of FIG. 11, SMF sends an N4 Session Establishment/Modification Request to UPF and provides the packet detection, enforcement, reporting rules to be installed on UPF for this PDU session, together with the XR traffic handling information. The XR traffic handling information can be provided explicitly or implicitly. That is, the XR traffic handling information may be explicitly an XR traffic indication. In this condition, the correlation of QFIs or PDR Rule IDs or PFD IDs can be optionally included in the XR traffic handling information. Alternatively, the XR traffic handling information may be only the correlation of QFIs or PDR Rule IDs or PFD IDs (i.e. XR traffic handling information is implicitly provided). The correlation of QFIs (e.g. the modified format) can be provided by the same manner described in section 1.1.2.1 or 1.1.2.2. The correlation of PDR Rule IDs or PFD IDs can be provided in a similar way to the correlation of QFIs.

In step 12 of FIG. 11, the correlation of QFIs will be provided by SMF to RAN node (e.g. gNB) over N2 SM information. If XR traffic configuration information also includes the packet characteristic information corresponding to the service flow filter (or flow description) or PFD, SMF shall also provide the mapping relationship between QFI and packet characteristic information in N2 SM information.

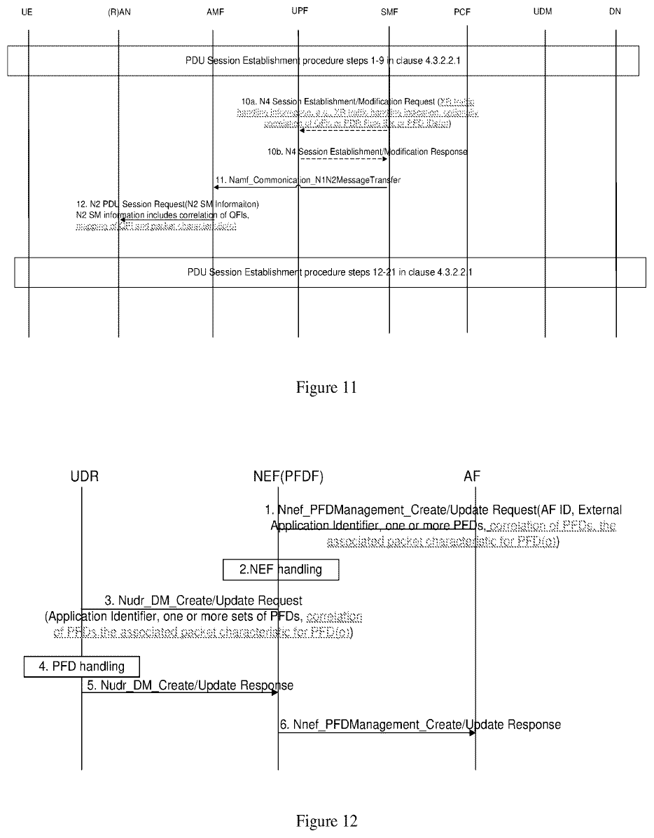

It is assumed that AF provides the XR traffic configuration information in the PFD(s) associated with application identifier. That is, each PFD includes XR traffic configuration information from AF. A modification to TS 23.502 4.18.2 (i.e., PFD management via NEF (PFDF)) is proposed, as shown in FIG. 12 (with modified portions underlined).

AF provides modified PFD that includes XR traffic configuration information in step 1, which are processed in NEF (e.g. in PFDF in NEF) (step 2) and stored in UDR (step 3).

Next, the PFD including the XR traffic configuration information is provided to SMF by one of the following three alternatives (not shown in FIG. 12):
Alternative a): Per node information provisioning to SMF. The PFDF in NEF shall provide PFD(s) to SMF on the request of SMF (pull mode) or on the request of PFD management from NEF (push mode).
Alternative b): Per node information is stored in UDR, and then notified to PCF and delivered to SMF via PCC rule (e.g. the PCC rule described as shown in FIG. 6.
Alternative c): Per node information provisioning to UPF.

SMF receives the modified PFD(s) by pull or push mode. By utilizing the PFD management in the UPF procedure defined in TS 23.502 FIG. 4.4.3.5-1, SMF provides the application identifier, and the following information associated with the application identifier: the associated PFD(s), the correlation of PFDs, and optionally the associated packet characteristic for PFD to UPF. During the PDU session establishment, PCF provides SMF with the application identifier in the PCC rules. SMF forwards the application identifier to UPF. UPF finds the associated PFD(s), and the correlation of PFDs and optionally the associated packet characteristic for PFD based on application identifier.

2.2 Second Sub-Embodiment of the Second Embodiment: Modified PDU Session Establishment Procedure with PCF Involved.

According to a second sub-embodiment of the second embodiment, a modified PDU session establishment procedure is introduced based on the assumption that PCF has obtained the XR traffic configuration information from AF.

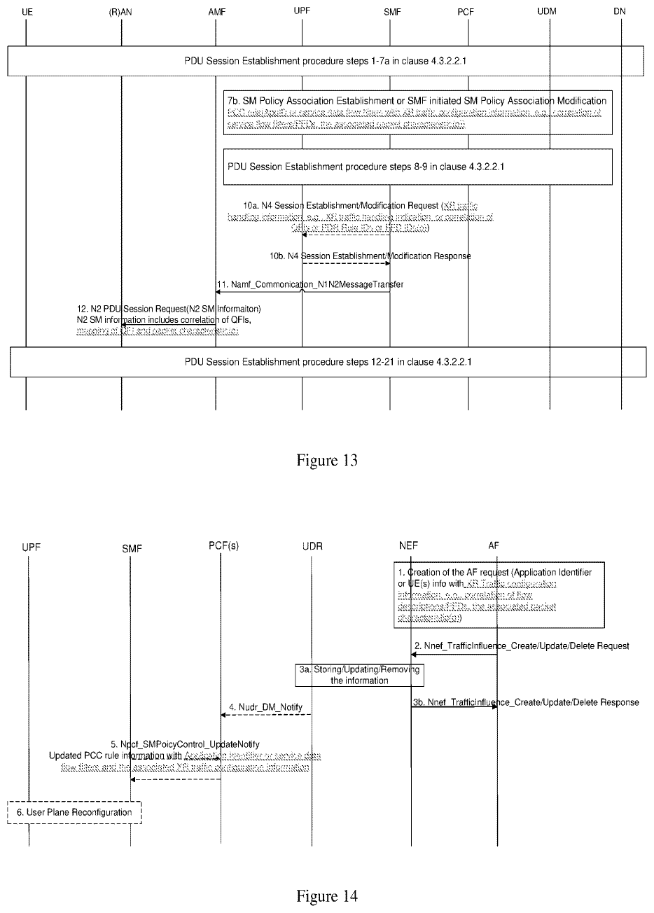

According to the second sub-embodiment of the second embodiment, UE requests a modified PDU session establishment procedure specified in TS 23.502 4.3.2.2.1 for non-roaming and roaming with local breakout case, with the following modifications as shown in FIG. 13 (with modifications underlined).

In modified Step 7b, SMF may perform an SM Policy Association Establishment procedure as defined in clause TS 23.502 4.16.4 to establish an SM Policy Association with PCF and get the default PCC rules for the PDU session. The modification to step 7b only relates to SMF getting PCC rules from PCF. In the PCC rules, Application Identifier (i.e., AppID) or service data flow filter (or flow description) and the associated XR traffic configuration information are provided. The XR traffic configuration information applies to the Application Identifier or the service data flow filters. Optionally, the applied Application identifier list or service data flow filter ID list can be provided together with the XR traffic configuration information from AF. That is, the XR traffic configuration information applies to the indicated Application identifier list or service data flow filter ID list.

The correlation of PFDs can be provided in one of the following manners:
Manner 1: Introducing PFD Group list with the associated PFD IDs, or PFD Group ID and the associated PFD IDs. For example, introducing PFD Group list with the associated PFD IDs, or PFD Group ID and the associated pfdId(s) into PfdData defined in TS 29.122 Table 5.11.2.1.3-1.
Manner 2: Introducing PFD Group ID or associated PFD ID(s) into the content of PFD (i.e., type Pfd defined in TS 29.122 Table 5.11.2.1.4-1), e.g., Pfd (pfdId, PFD Group ID, other IEs in the table). The PFDs that have the same PFG Group ID have correlation. Alternatively, Pfd (pfdId, associated pfdId list, other IEs in the table), where the pfdId and the associated pfdId list have correlation.

The correlation of service data flow filters or flow descriptions can be provided in a similar way to PFDs. Optionally, Application Identifier (i.e., AppID) or (AppID and PFD) or service data flow filter (or flow description) and the associated packet characteristic information are also provided.

2.2.1 how can PCF Acquire the XR Traffic Configuration Information from AF Before PDU Session Establishment?

PCF can acquire the XR traffic configuration information from AF before PDU session establishment by a modification of TS 23.502 4.3.6.2 (i.e., Processing AF requests to influence traffic routing for Sessions not identified by an UE address), as shown in FIG. 14 (with modifications underlined).

In modified step 1, AF request includes Application Identifier or UE(s) info with XR traffic configuration information from AF, where the XR traffic configuration information from AF can be correlation of flow descriptions (or service data flow filters) or PFDs. Optionally, the XR traffic configuration information may also include the packet characteristic information corresponding to the service flow filter (or flow description) or PFD.

In modified step 5, Application Identifier (i.e., AppID) or service data flow filters and the associated XR traffic configuration information from AF are provided in the new PCC rules.

### 2.3 Third Sub-Embodiment of the Second Embodiment: Modified PDU Session Modification Procedure.

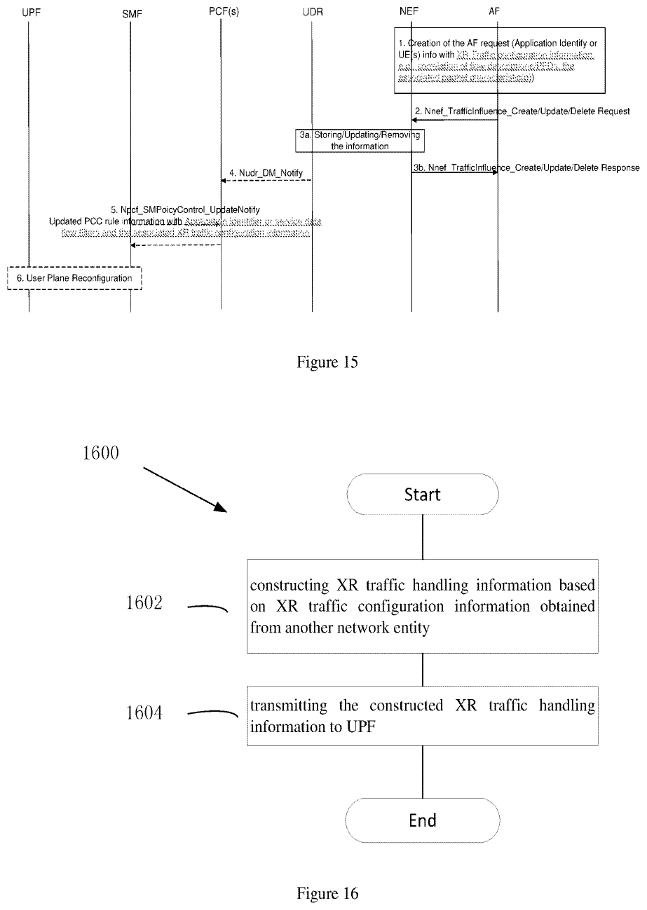

According to a third sub-embodiment of the second embodiment, a modified PDU session modification procedure is introduced based on the assumption that AF sends AF request upon the notification of PDU session establishment event. The procedure defined in TS 23.502 4.3.6.4 can be modified as FIG. 15 (with modifications underlined).

In modified step 1, the AF request includes the XR traffic configuration information, e.g., correlation of service flow filters (or flow descriptions) or PFDs, optionally the associated packet characteristic for PFD or service flow filter (or flow description), i.e., PFD ID or flow ID and the corresponding packet characteristic information.

In modified step 4, AF/NEF (i.e. AF or NEF) invokes the Npcf_PolicyAuthorization service to PCF to transfer the AF request. In the AF request, UE IP address, correlation of flow descriptions or PFDs, optionally the associated packet characteristic for PFD or flow description are included.

The corresponding PDU session modification procedure is the same as the procedure illustrated in FIG. 8 with reference to section 1.3. The only difference is that the XR traffic configuration information includes the correlation of flow descriptions or PFDs, optionally the associated packet characteristic for PFD or flow description.

### 2.4 Fourth Sub-Embodiment of the Second Embodiment: User Plane Handling of UPF (Common Part).

Comparing with the user plane handling of UPF described in the first embodiment 1, UPF does not need to split one IP packet flow into two or more QoS flows according to the second embodiment. If XR traffic handling indication is provided by SMF, UPF extracts the information from N6 interface to the extended GTP-U header (please refer to description of FIGS. 9(a), 9(b) and 10. If the correlation of QFIs or PDR Rule IDs of PRF IDs is provided, UPF may also perform efficient data dropping, e.g., the non-transmitted part of an XR frame will be discarded at the transmitter if any part of the frame has lost or exceeded the frame or ADU delay budget.

### 2.5 Summary of the Second Embodiment:

SMF constructs the XR traffic handling information (e.g., XR traffic indication or optionally the correlation of QFIs or PDR Rule IDs or PFD IDs) based on the XR configuration information from AF (e.g., correlation of service flow filters or PFDs, optionally the packet characteristic information corresponding to the service flow filter or PFD) received from either PCF as part of PCC rule, or from PFD Function in NEF as part of PFD management.

In response to receiving the XR traffic handling information (as an indication of extracting application-aware parameters from N6 interface) from SMF, UPF processes the packets carrying XR traffic. In particular, UPF extracts application-aware parameters from the N6 interface and pastes them into the extended GTP-U header of N3 or N9 interface.

SMF can inform gNB of the correlation of QFIs. Optionally, SMF can also inform gNB of the mapping relationship between QFI and the packet characteristic in order to reduce overhead of the extended GTP-U header.

FIG. 16 is a schematic flow chart diagram illustrating an embodiment of a method 1600 according to the present application. In some embodiments, the method 1600 is performed by a network function such as an SMF or a network function with an SMF. In certain embodiments, the method 1600 may be performed by a processor executing program code, for example, a microcontroller, a microprocessor, a CPU, a GPU, an auxiliary processing unit, a FPGA, or the like.

The method 1600 may comprise: 1602 constructing XR traffic handling information based on XR traffic configuration information obtained from another network entity; and 1604 transmitting the constructed XR traffic handling information to UPF.

Preferably, the XR traffic configuration information is XR traffic indication. In some embodiment, the XR traffic configuration information further includes possible values of packet characteristic information.

In one embodiment, the method further comprises obtaining the XR traffic configuration information as part of PCC rule from PCF. In another embodiment, the method further comprises obtaining the XR traffic configuration information as part of PFD management from PFD Function in NEF.

In some embodiment, the XR traffic handling information comprises mapping relationship between QFI and packet characteristic information.

In some embodiment, the method further comprises transmitting correlation of QFIs to a RAN node. Further, the method further comprises transmitting mapping relationship between QFI and packet characteristic information to the RAN node.

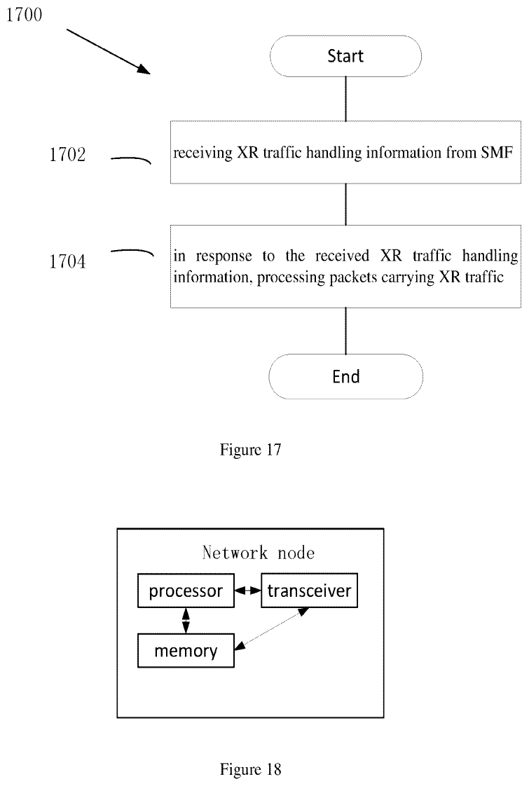

FIG. 17 is a schematic flow chart diagram illustrating an embodiment of a method 1700 according to the present application. In some embodiments, the method 1700 is performed by a network function such as an UPF or a network function with an UPF. In certain embodiments, the method 1700 may be performed by a processor executing program code, for example, a microcontroller, a microprocessor, a CPU, a GPU, an auxiliary processing unit, a FPGA, or the like.

The method 1700 may comprise 1702 receiving XR traffic handling information from SMF; and 1704 in response to the received XR traffic handling information, processing packets carrying XR traffic.

In one embodiment, the XR traffic handling information comprises mapping relationship between QFI and packet characteristic information. In this condition, processing packets carrying XR traffic comprising: marking each of the packets carrying XR traffic with a QFI based on the packet characteristic information received from user plane.

In another embodiment, processing packets carrying XR traffic comprising: extracting application-aware parameters from N6 interface and pasting them into extended GTP-U header of N3 or N9 interface.

FIG. 18 is a schematic block diagram illustrating apparatuses according to one embodiment.

The network function or network node or network entity (e.g. SMF or UPF) includes a processor, a memory, and a transceiver. The processor implements a function, a process, and/or a method which are proposed in FIG. 16 or 17.

The SMF comprises a processor and a transmitter coupled to the processor, wherein the processor is configured to construct XR traffic handling information based on XR traffic configuration information obtained from another network entity; and to transmit, via the transmitter, the constructed XR traffic handling information to UPF.

Preferably, the XR traffic configuration information is XR traffic indication. In some embodiment, the XR traffic configuration information further includes possible values of packet characteristic information.

In one embodiment, the processor is further configured to obtain the XR traffic configuration information as part of PCC rule from PCF. In another embodiment, the processor is further configured to obtain the XR traffic configuration information as part of PFD management from PFD Function in NEF.

In some embodiment, the XR traffic handling information comprises mapping relationship between QFI and packet characteristic information.

In some embodiment, the processor is further configured to transmit, via the transmitter, correlation of QFIs to a RAN node. Further, the processor is further configured to transmit, via the transmitter, mapping relationship between QFI and packet characteristic information to the RAN node.

The UPF comprises a processor and a receiver coupled to the processor, wherein the processor is configured to receive, via the receiver, XR traffic handling information from SMF; and to process packets carrying XR traffic in response to the received XR traffic handling information.

In one embodiment, the XR traffic handling information comprises mapping relationship between QFI and packet characteristic information. In this condition, to process packets carrying XR traffic comprising: to mark each of the packets carrying XR traffic with a QFI based on the packet characteristic information received from user plane.

In another embodiment, to process packets carrying XR traffic comprising: to extract application-aware parameters from N6 interface and paste them into extended GTP-U header of N3 or N9 interface.

Layers of a radio interface protocol may be implemented by the processors. The memories are connected with the processors to store various pieces of information for driving the processors. The transceivers are connected with the processors to transmit and/or receive message or information. Needless to say, the transceiver may be implemented as a transmitter to transmit the information and a receiver to receive the information.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A session management function (SMF) of a network architecture, comprising:
at least one memory; and
at least one processor coupled with the at least one memory and configured to cause the SMF to:
construct extended reality (XR) traffic handling information based on XR traffic configuration information obtained from a network entity; and
transmit, to a user plane function (UPF), the constructed XR traffic handling information.

2. The SMF of claim 1, wherein the constructed XR traffic handling information indicates the UPF to extract application-aware parameters from an N6 interface and paste the application-aware parameters into an extended general packet radio service (GPRS) tunnelling protocol user plane (GTP-U) header of an N3 interface or an N9 interface.

3. The SMF of claim 1, wherein the XR traffic configuration information is an XR traffic indication.

4. The SMF of claim 1, wherein the XR traffic configuration information further includes possible values of packet characteristic information.

5. The SMF of claim 1, wherein the at least one processor is further configured to cause the SMF to obtain the XR traffic configuration information as part of a policy and charging control (PCC) rule from a policy control function (PCF).

6. The SMF of claim 1, wherein the at least one processor is further configured to cause the SMF to obtain the XR traffic configuration information as part of packet flow description (PFD) management from a PFD function in a network exposure function (NEF).

7. The SMF of claim 1, wherein the XR traffic handling information comprises a mapping relationship between a quality of service (QoS) flow identifier (QFI) and packet characteristic information.

8. The SMF of claim 1, wherein the at least one processor is further configured to cause the SMF to transmit correlation of quality of service (QoS) flow identifiers (QFIs) to a radio access network (RAN) node.

9. The SMF of claim 7, wherein the at least one processor is further configured to cause the SMF to transmit, to a radio access network (RAN) node, the mapping relationship between the QFI and the packet characteristic information.

10. A user plane function (UPF) of a network architecture, comprising:
at least one memory; and
at least one processor coupled with the at least one memory and configured to cause the UPF to:
receive, from a session management function (SMF), extended reality (XR) traffic handling information; and
process packets carrying XR traffic in response to the received XR traffic handling information.

11. The UPF of claim 10, wherein the XR traffic handling information comprises a mapping relationship between a quality of service (QoS) flow identifier (QFI) and packet characteristic information.

12. The UPF of claim 11, wherein to process the packets carrying the XR traffic, the at least one processor is configured to cause the UPF to mark each of the packets carrying the XR traffic with the QFI based on the packet characteristic information received from a user plane.

13. The UPF of claim 10, wherein to process the packets carrying the XR traffic, the at least one processor is configured to cause the UPF to extract application-aware parameters from an N6 interface and paste them the application-aware parameters into an extended general packet radio service (GPRS) tunnelling protocol user plane (GTP-U) header of an N3 interface or an N9 interface.

14. A method performed by a session management function (SMF) of a network architecture, the method comprising:
constructing extended reality (XR) traffic handling information based on XR traffic configuration information obtained from a network entity; and
transmitting, to a user plane function (UPF), the constructed XR traffic handling information.

15. The method of claim 14, wherein the constructed XR traffic handling information indicates the UPF to extract application-aware parameters from an N6 interface and paste the application-aware parameters into an extended general packet radio service (GPRS) tunnelling protocol user plane (GTP-U) header of an N3 interface or an N9 interface.

16. The method of claim 14, wherein the XR traffic configuration information is an XR traffic indication.

17. The method of claim 14, wherein the XR traffic configuration information further includes possible values of packet characteristic information.

18. The method of claim 14, further comprising obtaining the XR traffic configuration information as part of a policy and charging control (PCC) rule from a policy control function (PCF).

19. The method of claim 14, further comprising obtaining the XR traffic configuration information as part of packet flow description (PFD) management from a PFD in a network exposure function (NEF).

20. A processor for wireless communication, comprising:
at least one controller coupled with at least one memory and configured to cause the processor to:
construct extended reality (XR) traffic handling information based on XR traffic configuration information obtained from a network entity; and
transmit, to a user plane function (UPF), the constructed XR traffic handling information.
